(19) United States
(12) Patent Application Publication
(10) Pub. No.: US 2018/0232875 A1
(43) Pub. Date: Aug. 16, 2018

(54) COSMETIC DEFECT EVALUATION

(71) Applicant: Pervacio Inc, Irving, TX (US)

(72) Inventors: Sanjay Kanodia, Irving, TX (US); Toni Kurvinen, Tampere (FI); Aninda Chatterjee, Bangalore (IN)

(73) Assignee: Pervacio Inc, Irving, TX (US)

(21) Appl. No.: 15/885,237

(22) Filed: Jan. 31, 2018

Related U.S. Application Data
(60) Provisional application No. 62/458,277, filed on Feb. 13, 2017.

(51) Int. Cl. G06T 7/00; G06T 5/50; G01N 21/88; H04N 5/225

(52) U.S. Cl. CPC G06T 7/0004; G06T 5/50; G01N 21/8806; G06T 2207/20221; H04N 5/2256; G06T 2210/12; H04N 5/2252

(57) ABSTRACT

A method for evaluating cosmetic defects of a device includes capturing a plurality of images of the device under a plurality of lighting conditions, processing the images of the device into one or more final images, identifying one or more defects of the device and computing a defect index from the one or more defects. The method may be performed with a system including one or more light sources, one or more cameras configured to capture a plurality of images of a device illuminated by the one or more light sources and one or more processors configured to control the lights sources and cameras, analyze the images captured by the one or more cameras, combine the images into a final image, identify one or more defects of the device and compute a defect index from the one or more defects.

### CROSS-REFERENCE TO RELATED APPLICATIONS

This application claims the priority benefit of U.S. Provisional Application No. 62/458,277 filed on Feb. 13, 2017 which is incorporated herein by reference in its entirety.

### SUMMARY

It is an object of the disclosure to provide a method for evaluating cosmetic defects of a device. The method includes capturing a plurality of images of an exterior of the device under a plurality of lighting conditions, processing the images of the device into one or more final images, identifying one or more defects of the device from the final images, computing a defect index based upon the identified one or more defects and issuing an evaluation of the device based upon the defect index in accordance with user-configured standards.

It is another object of the disclosure to provide a system for evaluating cosmetic defects of a device. The system includes a processor and at least one test rig configured to capture a plurality of images of an exterior of the device. The processor is configured to process images of the device captured by the at least one test rig into one or more final images, identify one or more defects of the device from the final images, compute a defect index based upon the identified one or more defects and issue an evaluation of the device based upon the defect index in accordance with user-configured standards.

The disclosure further seeks to provide a computer program product including a non-transitory computer-readable storage medium storing computer-executable code for evaluating cosmetic defects of a device. The code, when executed, is configured to cause one or more computers to record a plurality of images of an exterior of the device under a plurality of lighting conditions, process the images of the device into one or more final images, identify one or more defects of the device from the final images, compute a defect index based upon the identified one or more defects and issue an evaluation of the device based upon the defect index in accordance with user-configured standards.

It is yet another object of the disclosure to provide a method for evaluating cosmetic defects of a device which includes recording a plurality of images of the device under a plurality of lighting conditions, processing the images of the device into one or more final images, identifying one or more defects of the device in a defect map and computing a defect index from the one or more defects.

### BRIEF DESCRIPTION OF THE FIGURES

The summary above, as well as the following detailed description of illustrative embodiments, is better understood when read in conjunction with the appended drawings. For the purpose of illustrating the present disclosure, example constructions of the disclosure are shown in the drawings. However, the present disclosure is not limited to specific methods and instrumentalities disclosed herein. Moreover, those having ordinary skill in the art will understand that the drawings are not to scale. Wherever possible, like elements have been indicated by identical numbers.

Embodiments of the present disclosure will now be described, by way of example only, with reference to the following diagrams wherein:

FIG. 1 illustrates a flow of an example method suitable for practicing embodiments of the present disclosure.

FIG. 2 schematically illustrates an example system suitable for practicing embodiments of the present disclosure.

FIG. 3 illustrates an exterior, isometric view of an example test rig suitable for practicing embodiments of the disclosure.

FIG. 4 illustrates an interior, isometric view of an example test rig suitable for practicing embodiments of the disclosure.

FIG. 5 illustrates an interior, left side perspective view of an example test rig suitable for practicing embodiments of the disclosure.

FIG. 6 illustrates an interior, right side perspective view of an example test rig suitable for practicing embodiments of the disclosure.

FIG. 7 illustrates an interior, front perspective view of an example test rig suitable for practicing embodiments of the disclosure.

FIG. 8 illustrates an interior, back perspective view of an example test rig suitable for practicing embodiments of the disclosure.

FIG. 9 illustrates an interior, top perspective view of an example test rig suitable for practicing embodiments of the disclosure.

FIG. 10 illustrates an interior, bottom perspective view of an example test rig suitable for practicing embodiments of the disclosure.

FIG. 11 illustrates an interior, bottom isometric view of an example test rig suitable for practicing embodiments of the disclosure.

FIG. 12 schematically illustrates an example data processing unit in the form of a retail desktop module suitable for practicing embodiments of the present disclosure.

FIG. 13 schematically illustrates an example data processing unit in the form of a cosmetic defect evaluation server suitable for practicing embodiments of the present disclosure.

FIG. 14 illustrates a device exhibiting example defects in the form of cracks.

FIG. 15 illustrates a device exhibiting example defects in the form of scratches.

FIG. 16 illustrates a device exhibiting example defects in the form of dents.

### DETAILED DESCRIPTION

The following detailed description illustrates embodiments of the present disclosure and manners by which they may be implemented. Although the best mode of carrying out the present disclosure has been described, those of ordinary skill in the art would recognize that other embodiments for carrying out or practicing the present disclosure are also possible.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

In a trade-in scenario for a mobile device, the trade-in flow depends on a functional report provided by running diagnostics on the device. While accurate about the state of the device and its internal features, the diagnostics run on the device ignore the physical condition of the device as a factor in known trade-in evaluations. An LCD display screen is one of the most expensive components to replace on a device but damage such as cracks and scratches is not evaluated. Ignorance about the cosmetic state of the device leads to leakages when physically damaged but otherwise functional devices are valued higher than their practical worth.

There is no uniform way to classify different levels of scratches, cracks, dents and signs of use on different devices and/or grade the device on cosmetic factors. Value of a device can be much different when estimated by different persons. The retail agent receiving a device can evaluate the quality and wear quite differently from the warehouse that requires a definite resale grade for the device.

Embodiments of the present disclosure substantially eliminate, or at least partially address, problems in the prior art, providing a cosmetic defect checking/evaluating service to check for, detect and/or evaluate cosmetic defects of a device, in particular, a mobile device. The solution provides a view of the defects at different areas of an image and also creates a defect index for the device based on levels of defects and which sides are impacted.

Additional aspects, advantages, features and objects of the present disclosure will be made apparent from the drawings and the detailed description of the illustrative embodiments construed in conjunction with the appended claims.

An example method for evaluating cosmetic defects of a device includes recording a plurality of images of the device under a plurality of lighting conditions, processing the images of the device into one or more final images, identifying one or more defects of the device in a defect map and computing a defect index or score from the one or more defects. The method optionally includes repeating the recording, processing and identifying for a plurality of devices and recording a plurality of final images in a golden samples database for later comparison to newly evaluated devices.

An example system for evaluating cosmetic defects of a device includes one or more light sources, one or more cameras configured to capture a plurality of images of a device illuminated by the one or more light sources and one or more processors. The processors are configured to analyze the images captured by the one or more cameras to combine the images into a final image; identify one or more defects of the device in a defect map; and compute a defect index or score from the one or more defects. The one or more processors are optionally configured to compare the final image of the device to one or more pre-recorded final images in a golden samples database.

Further, a computer program product is disclosed which includes a non-transitory computer-readable storage medium storing computer-executable code for evaluating cosmetic defects of a device, wherein the code, when executed, is configured to cause one or more computers to evaluate cosmetic defects of a device.

Examples of mobile devices usable with disclosed methods and systems for cosmetic defect evaluation include, but are not limited to, mobile phones, smart telephones, Mobile Internet Devices (MIDs), tablet computers, Ultra-Mobile Personal Computers (UMPCs), phablet computers, Personal Digital Assistants (PDAs), wearable computing devices such as smart watches, web pads, handheld PCs, and laptop computers.

Users such as consumers, information technology resource providers, retailers and original equipment manufacturers associated with mobile devices use the defect evaluation services provided by disclosed systems and methods. A defect evaluation service can be offered free of cost or can be a paid service that has a subscription-based billing or a transaction-based billing, such as pay-per-use and pay-per-feature.

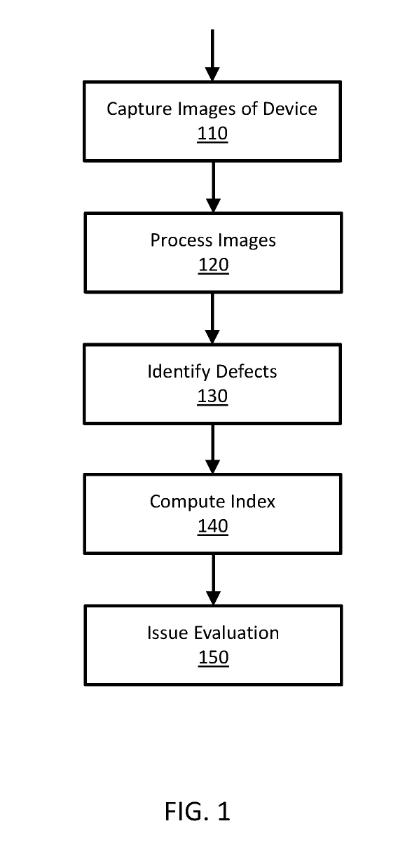

FIG. 1 illustrates a flow of an example method for evaluating cosmetic defects of a device. The method includes, at 110, capturing a plurality of images of an exterior of the device being tested with one or more cameras under a plurality of lighting conditions. Capturing the plurality of images may further include, for example, adjusting lighting conditions by adjusting one or more of light sources of a test rig and/or orienting the device being tested relative to one or more cameras and/or to one or more mirrors. The plurality of images of the device are captured, for example, with four or more cameras that are not all coplanar enabling capture of all sides of the exterior of the device without movement of the device.

The images of the device being tested are processed, at 120, into one or more final images using, for example, a high dynamic range algorithm. Processing of images into one or more final images may be executed by a desktop module or, in another example, by a server and may yield one or more composite images.

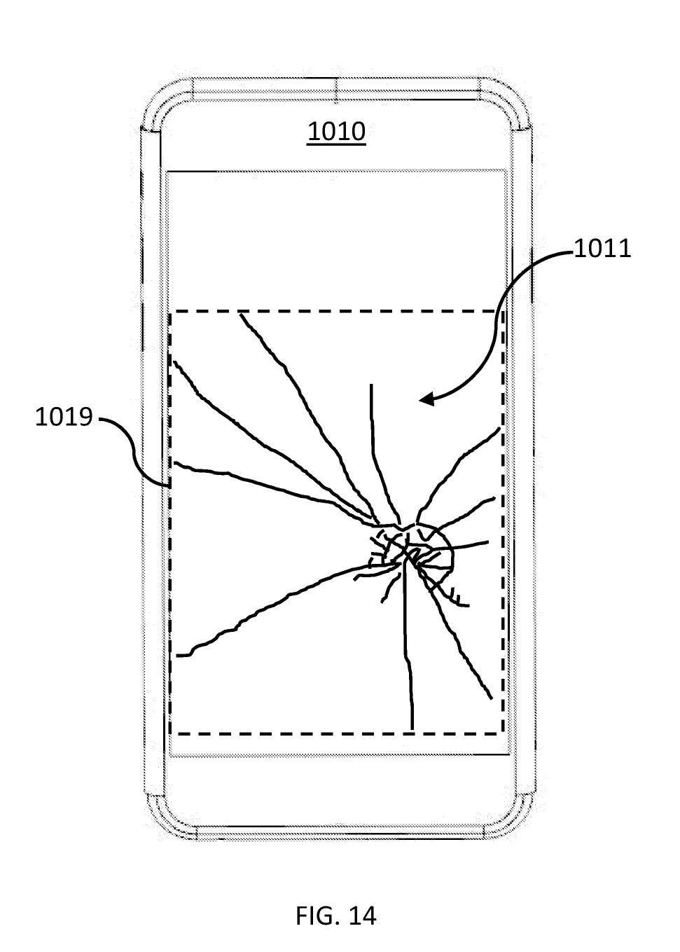

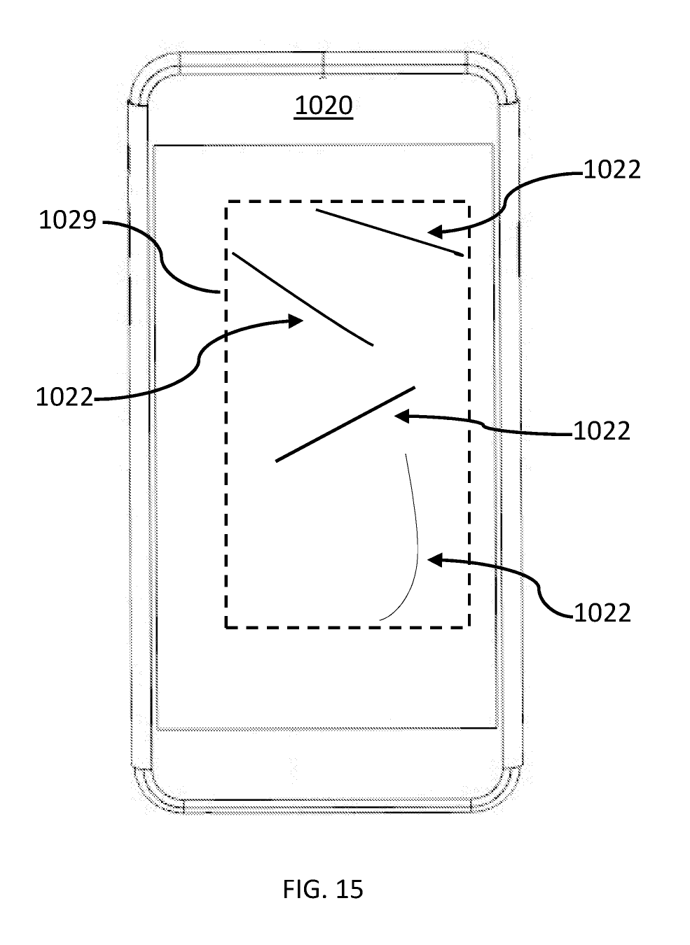

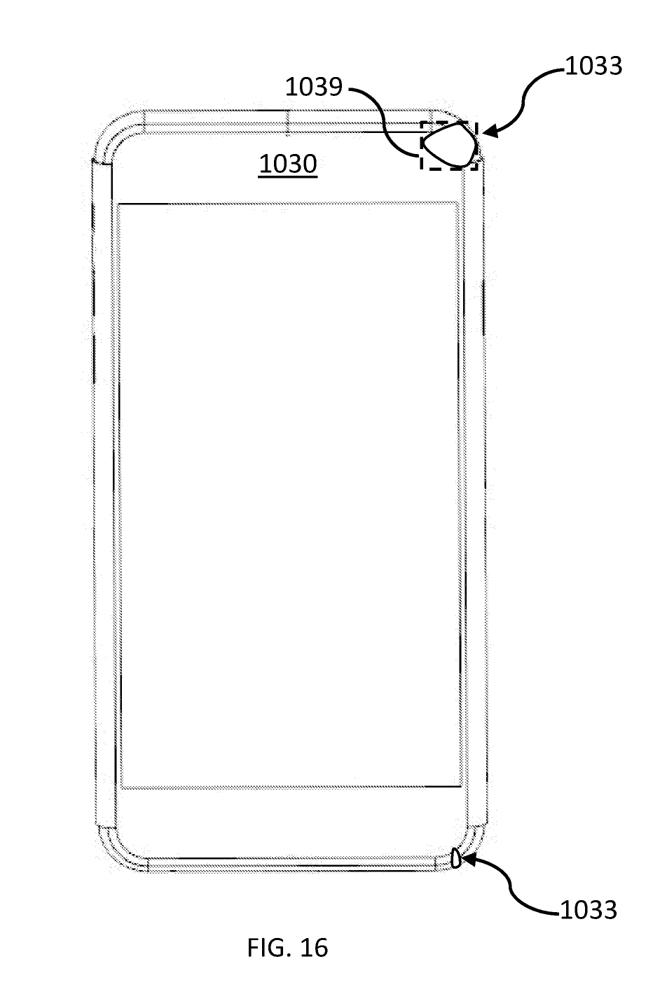

At 130 one or more defects of the device being tested, such as unevenness, scratches, wear, dents, cracks, discoloration or a combination of these are identified. Identifying one or more defects, which may further include distinguishing between unevenness, scratches, wear, dents, cracks or discoloration may be performed by a desktop module, or in another example, by a server. For example, one or more cracks 1011 (FIG. 14) are identified by, in part, distinguishing them from other defects such as scratches and dents. In another example, one or more scratches 1022 (FIG. 15) are identified by, in part, distinguishing them from other defects such as cracks and dents. In yet another example, one or more dents 1033 (FIG. 16) are identified by, in part, distinguishing them from other defects such as cracks and scratches.

In an example, identifying one or more defects of the device being tested may employ a deep learning neural network arranged to improve accuracy of defect identification in accordance with disclosed cosmetic defect evaluations. A technical analysis of captured images can be used to train the system and/or deep learning neural network to further improve accuracy.

When identifying and/or evaluating defects on a device and distinguishing between defective and non-defective regions, defect locations may be identified and/or a bounding box may be established delineating the defect(s). In order to identify locations of defects, the method may determine whether the defect is present on one or more of the front, rear, right side, left side, top or bottom of the device according to, for example, which camera of a test rig captured the defect. In order to establish a bounding box, the method may distinguish between defective and non-defective regions of the device. Bounding boxes may take any of a variety of shapes including but not limited to polygonal. In a further example, a bounding box may be a smallest rectangle containing all points of the defect such as with one of bounding boxes 1019, 1029 or 1039 (FIGS. 14-16).

Further, an intensity or severity for each of the one or more identified defects may be established and a defect index computed at 140 based upon the one or more identified defects and any established intensities. Establishing a severity for each of the one or more identified defects may further include identifying a location of the defect and/or determining a surface area of a bounding box associated with the defect. Intensities of the one or more identified defects may then be combined in order to compute the defect index. Defect index computation may be executed by a desktop module or, in another example, by a server.

In an example, each surface of a device being tested may be divided into sub-blocks and a sum of all sub-block defect levels is converted to individual block scores for each block on the surface of the device being tested. Surface scores are calculated for each individual surface of the device, a weighted sum of surface scores is computed and the individual, weighted surface scores are summed to yield the total score. For example, a back surface of a device may be weighted lower than other surfaces of a device since the back is least visible during use. Similarly, a front surface of a device may be weighted higher than other surfaces of a device since the front is most visible during use.

In an example, a defect index is computed by finding a total defect weight of a device being tested, dividing the weight by a parameter, subtracting the quotient from unity and multiplying the difference by 100. 3078 is an example of a parameter value. With a total defect weight of 3000, the resulting defect index is 2.53 reflecting a device with heavy cosmetic damage and low resale or reuse value. Given the same parameter, a device with a total defect weight of 500 results in a defect index of 83.8 reflecting a device with light cosmetic damage and high resale or reuse value. In an example, a monetary value for a mobile device is derived from the defect index.

With a defect index computed, an evaluation of the device being tested may be issued at 150 based upon the defect index in accordance with user-configured standards. For example, the defect index may be compared with a threshold set by the user such that a defect index higher than the threshold yields a device evaluation reflecting an unsatisfactory cosmetic condition of the device while a defect index below the threshold yields a device evaluation reflecting a satisfactory cosmetic condition. In an example, if a user sets a defect index threshold at 65 and the defect index computed for a device being tested is 70, the evaluation issued by the processor may indicate “Failed” or similar message reflecting the device is too severely damaged to re-enter the use stream. In another example, if a user cannot accept any cosmetic damage to the front of a device, the user may set a threshold defect index for the front at 0 so any damage to the front results in an indication that the device is too severely damaged to re-enter the use stream.

In an example, the evaluation issued is presented to a user interface including a display. The display may be part of a desktop module. In another example, the evaluation may be issued to a cosmetic defect evaluation server.

When any of starting images, final images, defect identities, defect intensities, defect locations, defect bounding boxes, defect indices and evaluations of devices being tested are obtained, one or more of these may be provided to a historical storage at a database in association with a server. As such, these data may be employed for improving the effectiveness of identifying defects through ongoing training of a machine learning component, such as a deep learning neural network.

The actions 110 to 150 are only illustrative and other alternatives can also be provided where one or more actions are added, one or more actions are removed, or one or more actions are provided in a different sequence without departing from the scope of the claims herein.

The disclosure further seeks to provide a computer program product or software product including a non-transitory or non-transient computer-readable storage medium storing computer-executable code for evaluating cosmetic defects of a device being tested. The code, when executed, is configured to perform the actions 110 to 150 of the method as described in conjunction with FIG. 1. As actions of the disclosed methods may be provided in different sequences, so the computer-executable code may be configured to provide a service having a different sequence of actions from those illustrated in FIG. 1. In some examples, the computer program product and code thereof may be downloaded from a software application store, for example, from an “App store”, to a data processing unit.

Descriptions which follow include hardware which may be arranged to implement actions of the above methods, for example, by executing the computer program product or parts thereof.

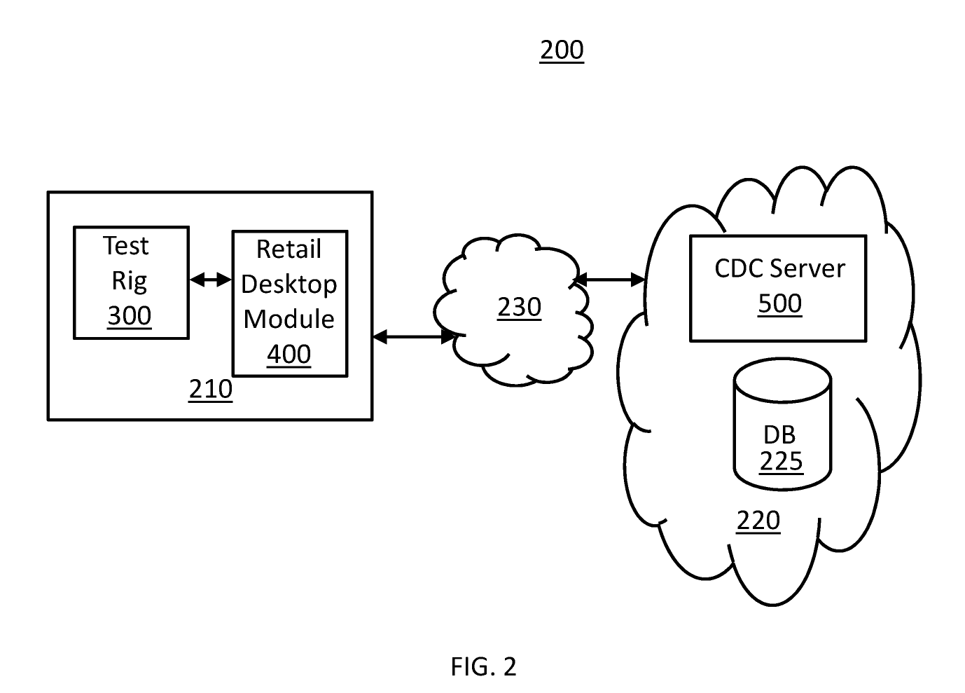

FIG. 2 schematically illustrates an example system 200 for evaluating cosmetic defects of a device. The system includes a retail subsystem 210 having a retail desktop module 400 operatively coupled with a test rig 300 as well as a server subsystem 220 having a server 500 operatively coupled with a database 225.

Subsystems 210 and 220 may be communicatively coupled by a communication network 230. The communication network can be a collection of individual networks, interconnected with each other and functioning as a single large network. Such individual networks may be wired, wireless, or a combination thereof. Examples of such individual networks include, but are not limited to, Local Area Networks (LANs), Wide Area Networks (WANs), Metropolitan Area Networks (MANs), Wireless LANs (WLANs), Wireless WANs (WWANs), Wireless MANs (WMANs), the Internet, second generation (2G) telecommunication networks, third generation (3G) telecommunication networks, fourth generation (4G) telecommunication networks, and Worldwide Interoperability for Microwave Access (WiMAX) networks.

System 200 may be implemented in various ways, depending on various possible scenarios. In one example scenario, system 200 may be implemented by way of a spatially collocated arrangement of server and database. In another example scenario, the system may be implemented by way of a spatially distributed arrangement of server and database coupled mutually in communication via a communication network. In yet another example scenario, server 500 and the database 225 may be implemented via cloud computing services. Retail desktop module 400 and/or server 500 may substantially continuously record and update changes in database 225.

Examples of data processing units usable with or as part of disclosed systems and methods and implementable as, for example, retail desktop module 400 and/or server 500 include, but are not limited to tablet computers, web pads, Personal Computers (PCs), handheld PCs, laptop computers, desktop computers, Network-Attached Storage (NAS) devices, large-sized touch screens with embedded PCs, and interactive entertainment devices, such as game consoles, Television (TV) sets and Set-Top Boxes (STBs).

System 200 is suitable for implementing various systems for determining and/or evaluating cosmetic defects of one or more mobile devices. In order to implement a system for determining and/or evaluating cosmetic defects, server 500 may provide a service to retail desktop modules 400 and mobile devices, while database 225 may store data related to starting images, final images, defect identities, defect intensities, defect locations, defect maps, defect bounding boxes, defect indices, golden standards/samples, evaluations of devices being tested or a combination of these.

Optionally, retail desktop module 400 or one or more other data processing units may access server 500 to download one or more applications or computer program products associated with a cosmetic defect evaluation service including, but not limited to, that disclosed above with reference to FIG. 1. In one embodiment, system 200 is arranged in a manner that its functionality is implemented partly in retail desktop module 400 and partly in server 500. In another embodiment, the system is arranged in a manner such that its functionality is implemented substantially in retail desktop module 400 by way of downloaded applications and/or computer program products. In such an implementation, retail desktop module 400 may be coupled to server 500 periodically or randomly from time to time, for example, to receive updates therefrom and/or to upload status or collected data thereto.

It is to be understood that the specific description for system 200 is provided as an example and is not to be construed as limiting the system to specific numbers, types, or arrangements of data processing units, servers, databases and communication networks. A person skilled in the art will recognize many variations, alternatives, and modifications of embodiments of the disclosure.

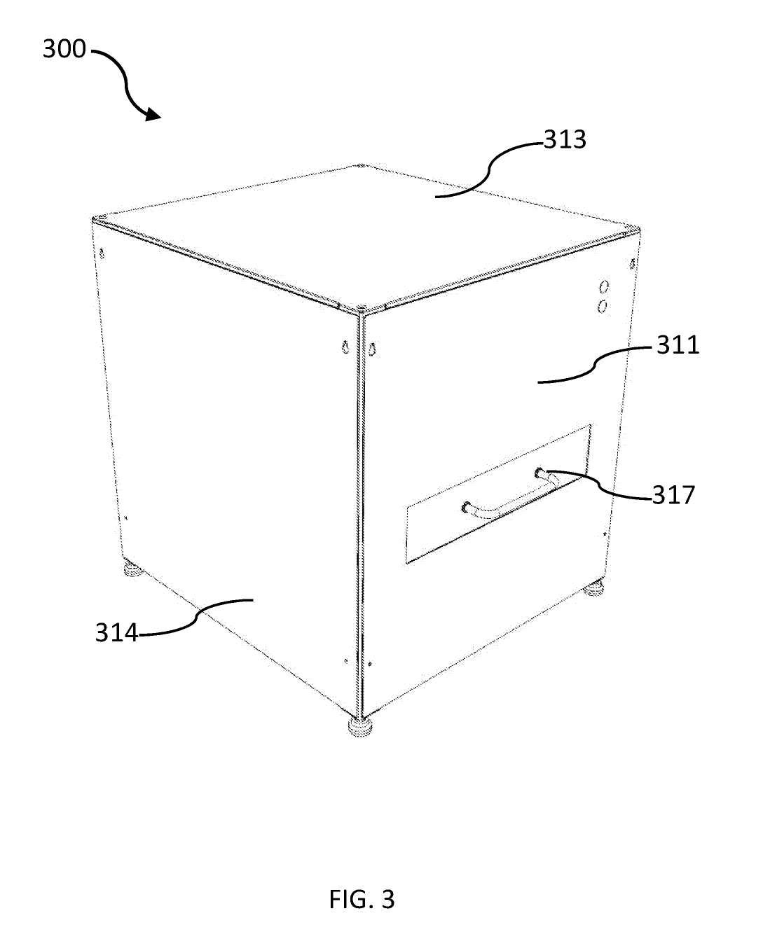

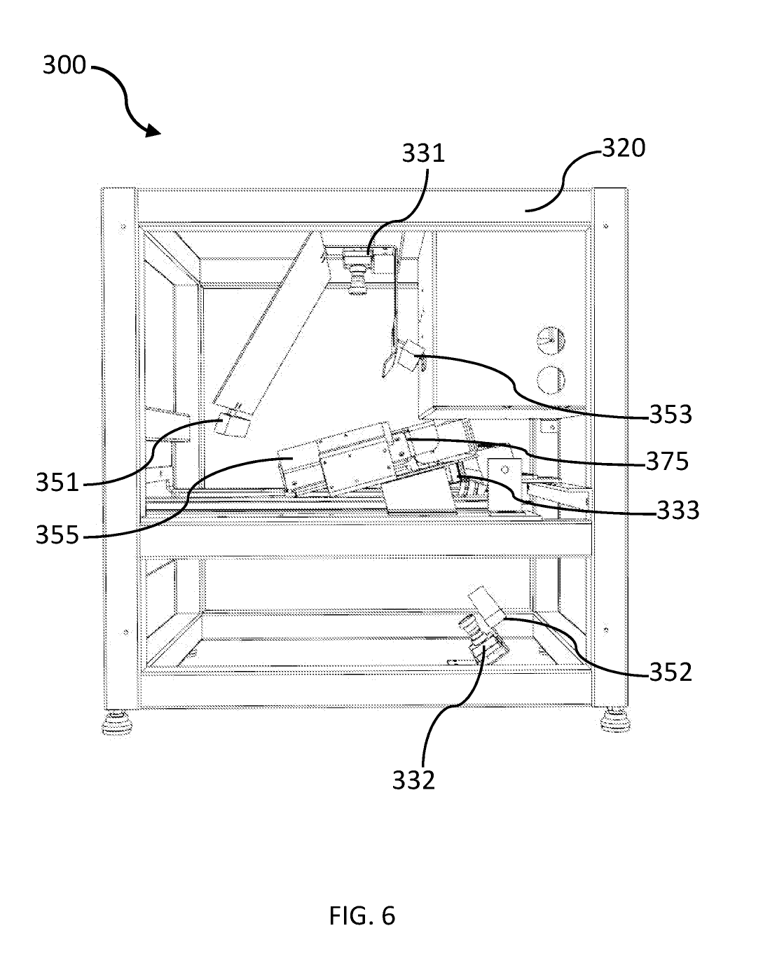

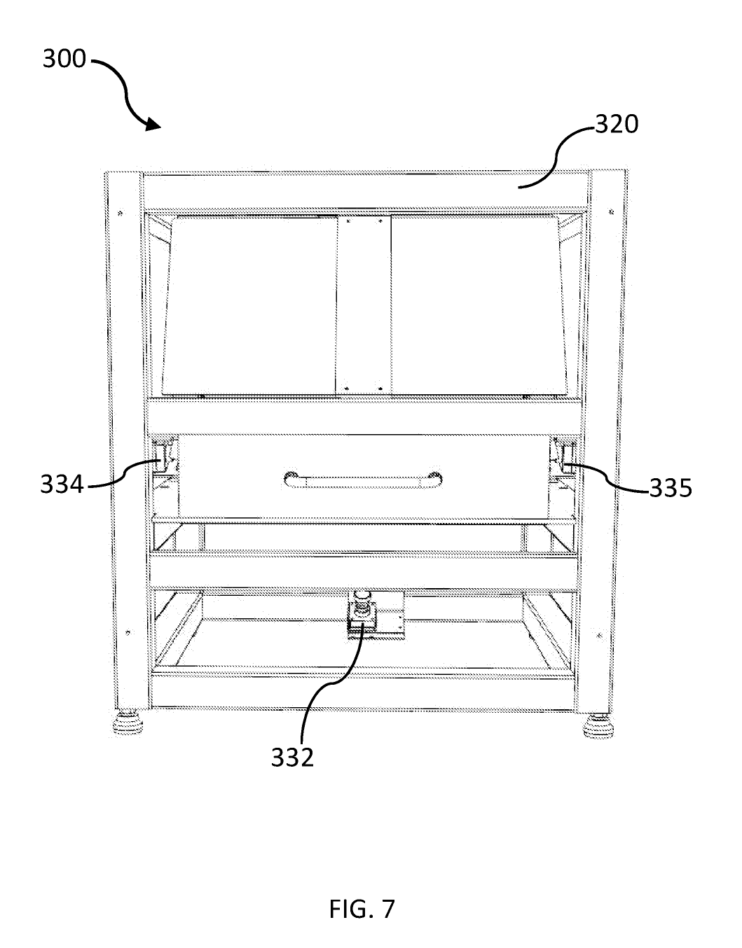

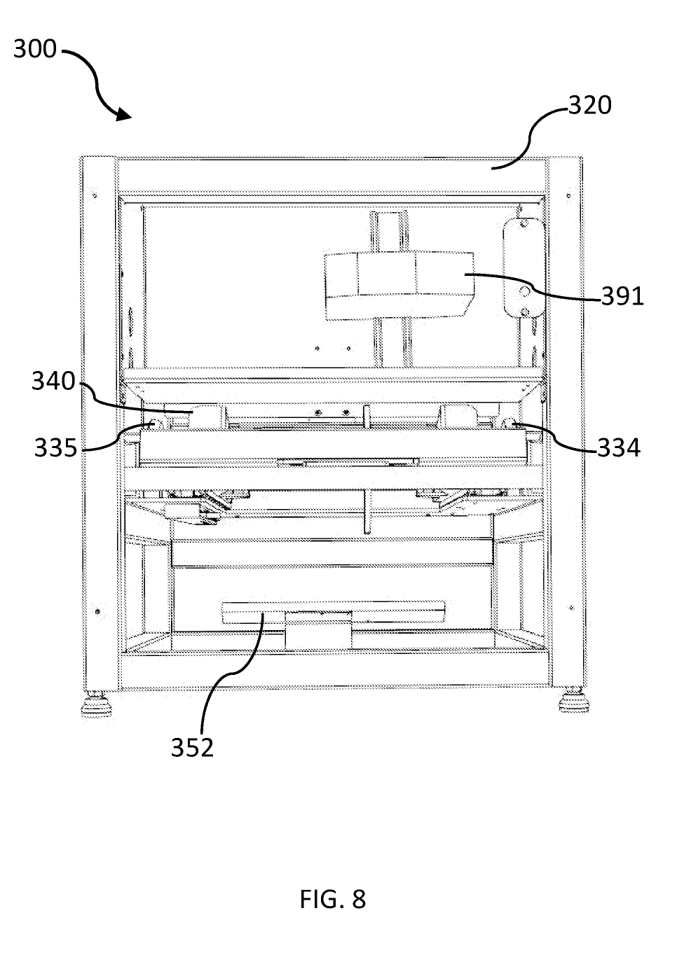

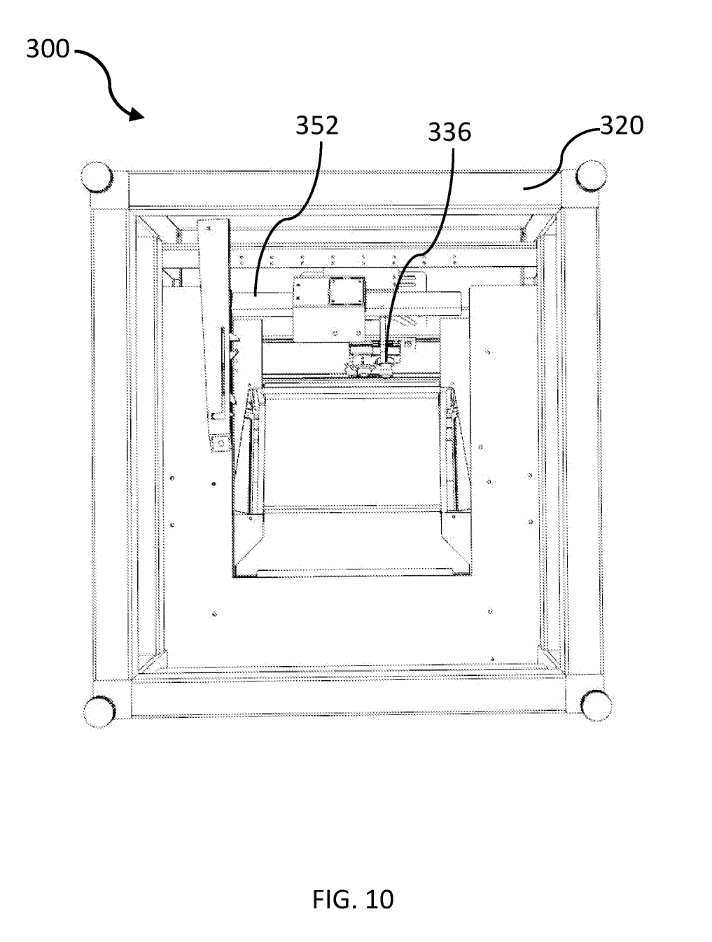

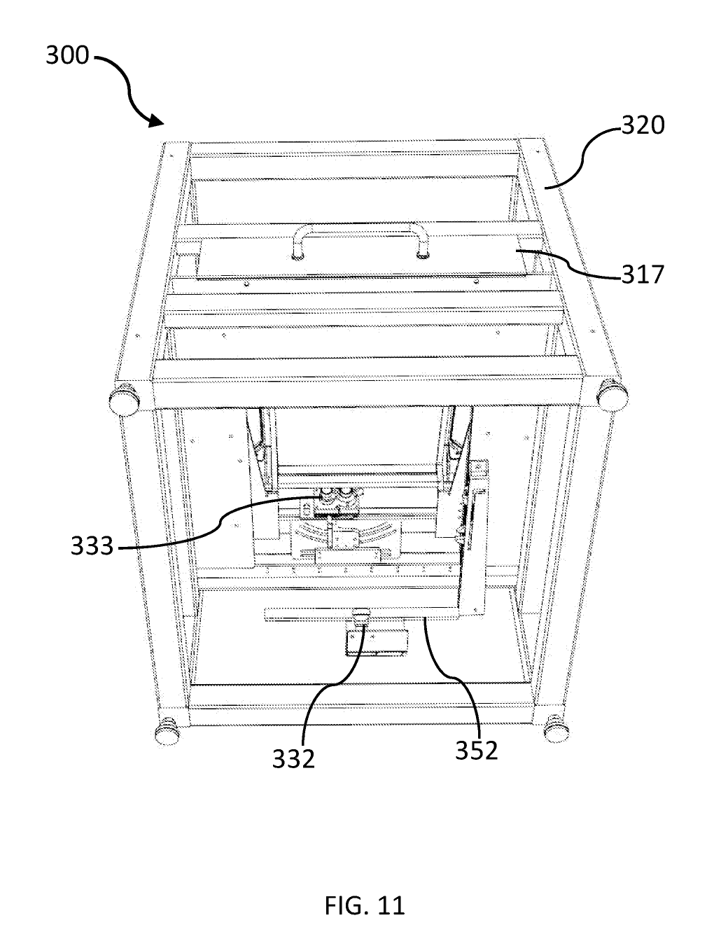

FIGS. 3-11 schematically illustrate an example of a test rig 300 suitable for practicing embodiments of the disclosure. Test rig 300 is provided for supporting a mobile device being tested in closely controlled lighting scenarios and enabling capture of images of the mobile device exterior from a variety of sides and angles without necessitating movement of the device. For example, it is not necessary to flip the device. Test rig 300 houses a number of cameras and light sources. Lighting conditions may be adjusted by adjusting one or more of light sources 350 of test rig 300 and/or by orienting a device being tested relative to one or more cameras 330 and one or more mirrors 370. Light sources may be adjusted in any of a variety of ways including but not limited to adjusting brightness and adjusting angle.

Test rig 300 may take any of a variety of shapes including but not limited to rectangular prism and, in an example, includes a frame 320 supporting internal components of rig 320 as well as cabinet panels 311, 313 and 314 (and three others, not visible) for sealing off the rig interior from external and/or ambient light sources. In this respect, test rig 300 may serve as a dark box. Test rig 300 may be constructed from any of a variety of sturdy, durable materials including but not limited to glass, plastics, metals, woods or combinations thereof. Further test rig 300 may take any of a variety of sizes suitable for being supported by/on a desktop or a table.

With drawer 317 partially withdrawn from the internal space of rig 300, a mobile device being tested may be placed in drawer 317 within a harness 340. Moving drawer 317 back into the internal space of rig 300 positions the device for image capture. Harness 340 facilitates positioning of the device and prevents undesired movement during image capture. In an example, harness 340 is constructed from glass or other transparent material such that no part of a device exterior is obscured by the harness and the device does not need to be released from harness 340, re-oriented and restrained again in order to capture all images necessary for defect evaluation.

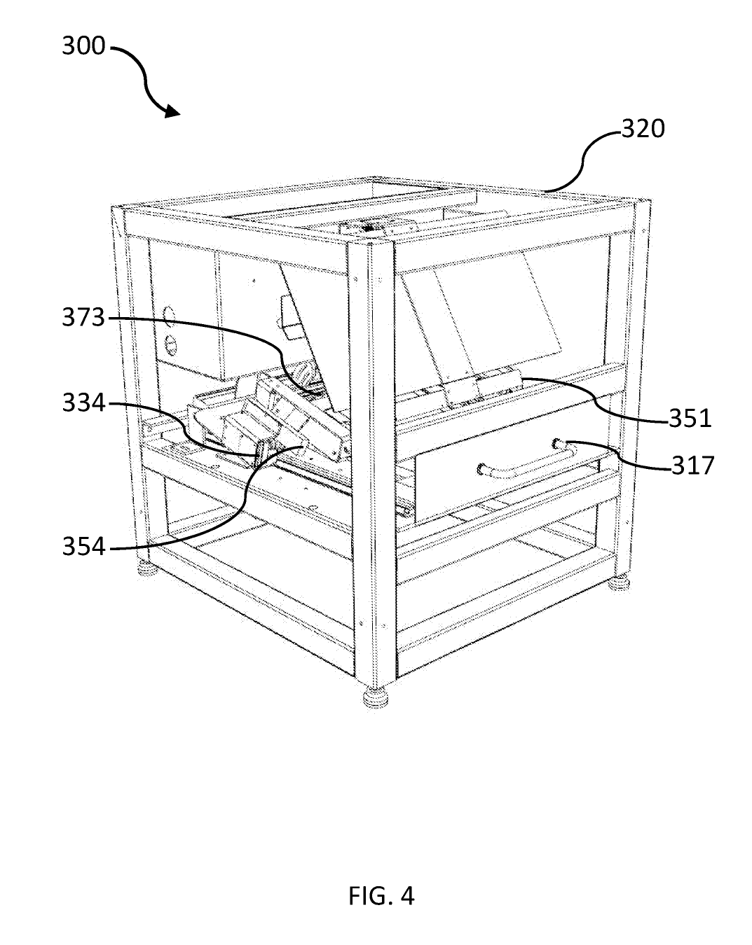

Capturing the plurality of images of all sides of the exterior of a device being tested without movement thereof may be enabled by capturing the images of the device with four or more cameras that are not all coplanar. For example, referring to FIGS. 4-8, a plane defined through the centers of three or more of cameras 331, 332, 333, 334 and 335 does not intersect every camera of test rig 300.

In an example arrangement of cameras, one or more left side cameras 334 are directed towards a central, interior region of test rig 300; one or more right side cameras 335 are directed towards the central, interior region of test rig 300; one or more rear cameras 333 are directed towards the central, interior region of test rig 300; one or more bottom cameras 332 are directed towards the central, interior region of test rig 300; and one or more top cameras 331 are directed towards the central, interior region of test rig 300.

Any of a variety of equipment may be used to provide cameras suitable for test rig 300. For example, a camera may include a sunex dsl355a-650-f2.8 lens. Further, example cameras suitable for capturing images in accordance with the disclosure include but are not limited to Basler DAA2500-14UC/S, color 2592×1944/14 fps S-mount.

In an example arrangement of light sources, one or more left side light sources 354 are directed towards a central, interior region of test rig 300; one or more right side light sources 355 are directed towards the central, interior region of test rig 300; one or more front light sources 351 are directed towards the central, interior region of test rig 300; one or more bottom light sources 352 are directed towards the central, interior region of test rig 300; and one or more top light sources 353 are directed towards the central, interior region of test rig 300. The light sources may be arranged in any of a variety of configurations. For example, a plane defined through centers of three or more of the light sources does not intersect every light source of the test rig.

Further, test rig 300 may include a plurality of mirrors 374, 375, arranged to reflect light from one or more of light sources 351, 352, 353, 354 and 355 to the central, interior region or to one or more of cameras 330.

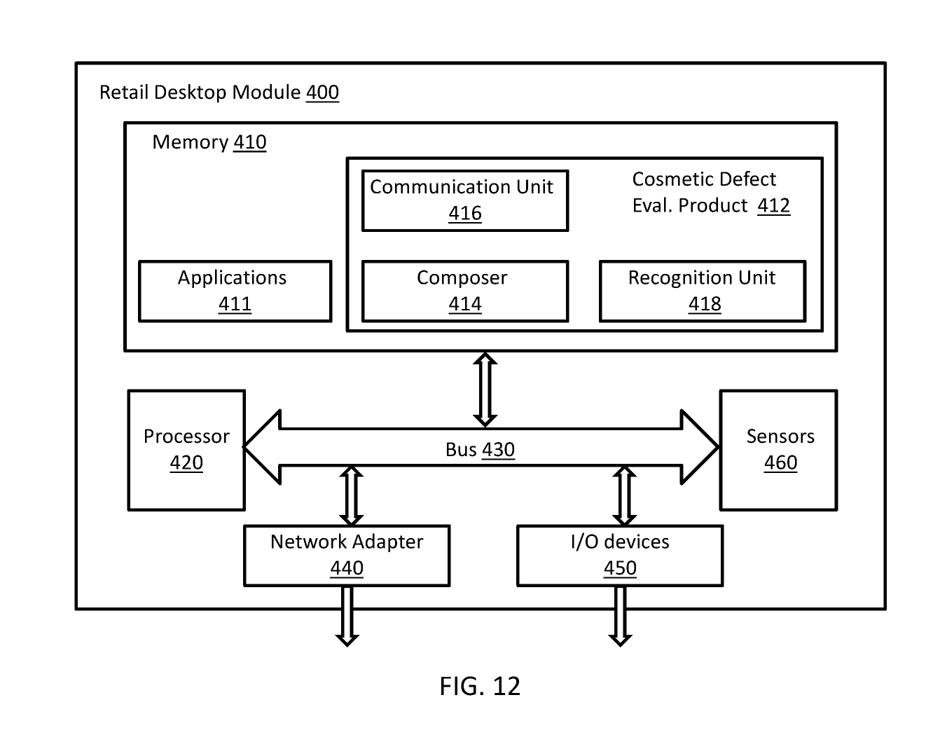

FIG. 12 schematically illustrates an example data processing unit in the form of a retail desktop module 400 suitable for practicing embodiments of the disclosure and for inclusion as part of system 200. Retail desktop module 400 includes, but is not limited to, a memory 410, a computing hardware such as a processor 420, a network adapter 440, I/O devices 450, a configuration of sensors 460 and a system bus 430 that operatively couples various components including memory 410, processor 420, I/O devices 450, network adapter 440 and sensors 460. I/O devices 450 include a display screen for presenting graphical images to a user of retail desktop module 400. Retail desktop module 400 also includes a power source (not shown) for supplying electrical power to the various components. The power source may, for example, include a rechargeable battery.

The memory 410 optionally includes non-removable memory, removable memory, or a combination thereof. Non-removable memory, for example, includes Random-Access Memory (RAM), Read-Only Memory (ROM), flash memory, or a hard drive. Removable memory, for example, includes flash memory cards, memory sticks, or smart cards.

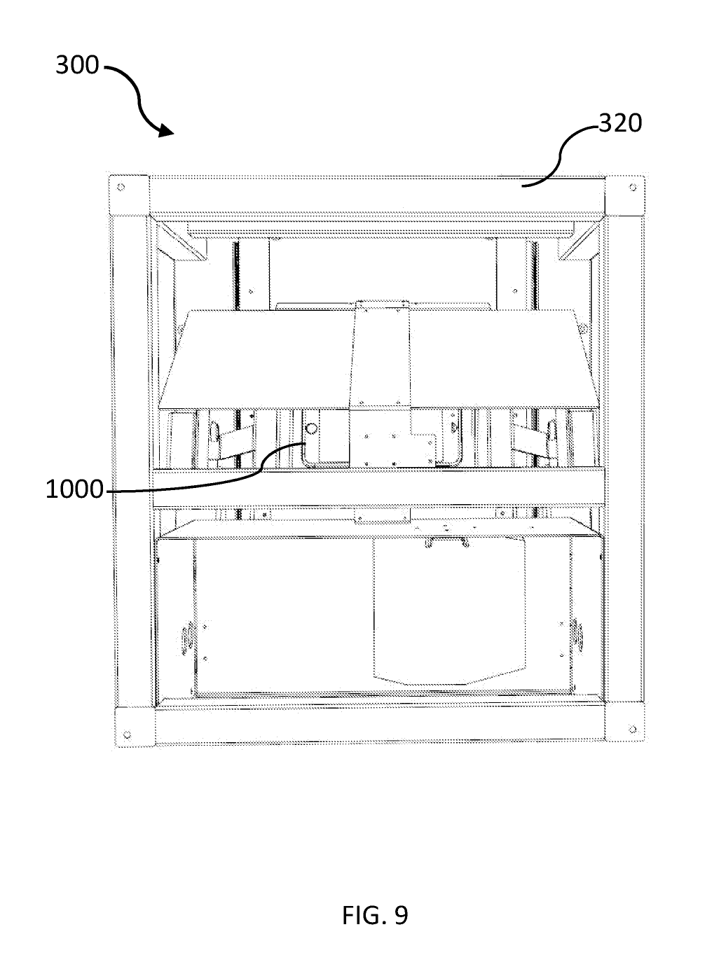

Memory 410 stores applications 411, a composer 414, a communication unit 416 and a recognition unit 418. Composer 414, communication unit 416 and recognition unit 418 may, for example, be parts of a computer program product 412 associated with the cosmetic defect evaluation service provided by cosmetic defect server 500 and components of retail desktop module 400. Executing the computer program product on processor 420 results, in part, in generating and rendering a graphical user interface on the display screen in accordance with I/O devices 450 and communication unit 416. The graphical user interface is configured to facilitate user interactions with the cosmetic defect evaluation system and associated services. Further, the processor and interface may be configured for displaying or otherwise presenting images produced by test rig 300 and/or evaluations of a device being tested such as device 1000 (FIG. 9). For example, one or more final images of a device being tested, defect sizes, defect numbers and defect bounding boxes may be displayed.

In some examples, the display screen may be a touch-sensitive display screen that is operable to receive tactile inputs from the user. These tactile inputs may, for example, include clicking, tapping, pointing, moving, pressing and/or swiping with a finger or a touch-sensitive object like a pen. Various functions of the cosmetic defect evaluation system and service may be accessed and or controlled through the tactile inputs.

Additionally or alternatively, I/O devices 450 may include a mouse or a joystick operable to receive inputs corresponding to clicking, pointing, and/or moving a pointer object on a graphical user interface. I/O devices 450 may also include a keyboard operable to receive inputs corresponding to pushing certain buttons on the keyboard. Additionally, I/O devices 450 may also include a microphone for receiving an audio input from the user, and a speaker for providing an audio output to the user.

Moreover, sensors 460 may include one or more of: a camera, an accelerometer, a magnetometer, a pressure sensor, a temperature sensor, a gyroscopic sensor, a Global Positioning System (GPS) sensor, or a timer.

Retail desktop module 400 is operatively coupled with test rig 300 for controlling cameras and light sources. For example, one or more cameras may be operated in sequence to capture images of the device being tested while one or more light sources are illuminated in sequence and/or in cooperation with the one or more cameras. In another example, all cameras may capture images simultaneously while all light sources are illuminated.

Example cameras included as sensors 460 may be provided external to any structure housing other components of retail desktop module 400. In one embodiment, cameras implemented as part of sensors 460 may be included with or otherwise housed with test rig 300 of FIGS. 3-11 and are arranged to capture images of a mobile device being tested.

Sensors 460 may be used to measure and collect data related to characteristics of a mobile device being tested such as defects, defect characteristics and defect locations. Additionally, outputs generated by sensors 460 may, for example, be indicative of surroundings of a user of retail desktop module 400. In some examples, the computer program product may be interfaced with sensors 460. When executed on processor 420, the computer program product is configured to resolve and integrate outputs of sensors 460 into useful information about at least one of defects, defect characteristics, defect locations present on a mobile device being tested.

Moreover, the computer program product, when executed on processor 420, is optionally coupled to memory 410, and is configured to record and therein update data collected and/or measured by sensors 460. Additionally, the computer program product, when executed on processor 420, may store output from processor 420 in memory 410. Such output may, for example, include at least one of final images of a device being tested, defect sizes, defect numbers and device evaluations.

Furthermore, network adapter 440 optionally enables retail desktop module 400 to upload output from processor 420, such as that stored to memory 410, to server 500. For example, retail desktop module 400 may upload to server 500 via communication network 230. Additionally, network interface 440 may enable retail desktop module 400 to access server 500 to update the computer program product and/or download one or more new computer program products associated with the defect evaluation system and/or service. Moreover, network interface 440 optionally allows retail desktop module 400 to communicate with other retail desktop modules and data processing units, for example, via communication network 230.

Retail desktop module 400 is optionally implemented by way of at least one of: an MID, a tablet computer, a UMPC, a PDA, a web pad, a PC, a handheld PC, a laptop computer, a desktop computer, an NAS device, a large-sized touch screen with an embedded PC, and an interactive entertainment device, such as a game console, a TV set and an STB.

Images captured by a test rig under a variety of lighting conditions may be combined by retail desktop module 400 to yield high fidelity images enabling detection of all present defects. Upon execution of the computer program product, processor 420 is adapted and/or configured to process captured images of the device being tested into one or more final images. In an example, final images may include a bounding box distinguishing between defective and non-defective regions.

In an example, the computer program product includes one or more modules including a composer 414. When activated by processor 420, composer 414 is configured to process images of the device being tested. Processing images of the device, includes, but is not limited to producing one or more final or composite images. Composer 414 may combine images in any of a variety of ways including by high dynamic range algorithms.

In an example, retail desktop module 400 also evaluates images for cosmetic defects. Upon execution of the computer program product, processor 420 is adapted and/or configured to identify, from the final images, one or more defects of the device being tested. For identifying one or more defects, recognition unit 418, when executed on the processor 420, may also be configured to distinguish between unevenness, scratches, wear, dents, cracks, discoloration or a combination of these. In an example, identifying one or more defects of the device further comprises employing a deep learning neural network constructed from training sessions with different defects. Such a deep learning neural network may be implemented as a component of recognition unit 418.

The processor may be further configured, for example in accordance with recognition unit 418, to identify a location for one or more of the identified defects of the device. For example, the processor may determine a defect is present on one or more of the front, rear, right side, left side, top or bottom of the device according to which camera of a test rig captured the defect.

Processor 420 is further configured, for example in accordance with recognition unit 418, to determine and/or compute a surface area of a bounding box delineating one or more of the identified defects of the device.

Processor 420 may be configured to establish an intensity or severity for each of the one or more identified defects. The severity of a defect may be evaluated in any of a number of ways. For example, the area of the bounding box may reflect the size and, therefore, severity of a defect. In another example, the depth of the defect may reflect the severity of the defect. In yet another example, area and size and, optionally, one or more additional characteristics reflect the severity of a defect. Establishing severity may be accomplished in accordance with execution of recognition unit 418 on processor 420.

Computation of a defect index may be executed by retail desktop module 400. Processor 420 may compute a defect index based upon the one or more identified defects.

The defect index may be computed from one or more of a location for one or more of the identified defects and a combined surface area of bounding boxes delineating the one or more of the defects of the device being tested. In an example, one or more defects located on a front surface of a device being tested may yield a higher defect index than one or more defects located on a back surface of the device.

In another example, computing the defect index may further include combining the severities of one or more identified defects in a weighted sum. In another example, computing the defect index further comprises determining a quotient of the combined intensities and a constant based upon user preferences and/or settings. In an example, the retail desktop module also generates defect maps of tested mobile devices and generates defect indices therefor.

With a defect index computed, the processor is configured to issue an evaluation of the device being tested. Communication unit 416, when executed on processor 420, may be configured to issue the evaluation based upon the severity of one or more defects and/or based upon the defect index in accordance with user-configured standards. For example, the evaluation issued by the processor may indicate “Failed” or similar message reflecting the device is too severely damaged to re-enter the use stream.

FIG. 12 is merely an example, which should not unduly limit the scope of the claims herein. It is to be understood that the specific designation for retail desktop module 400 is provided as an example and is not to be construed as limiting retail desktop module 400 to specific numbers, types, or arrangements of modules and/or components of retail desktop module 400. A person skilled in the art will recognize many variations, alternatives, and modifications of embodiments of the disclosure.

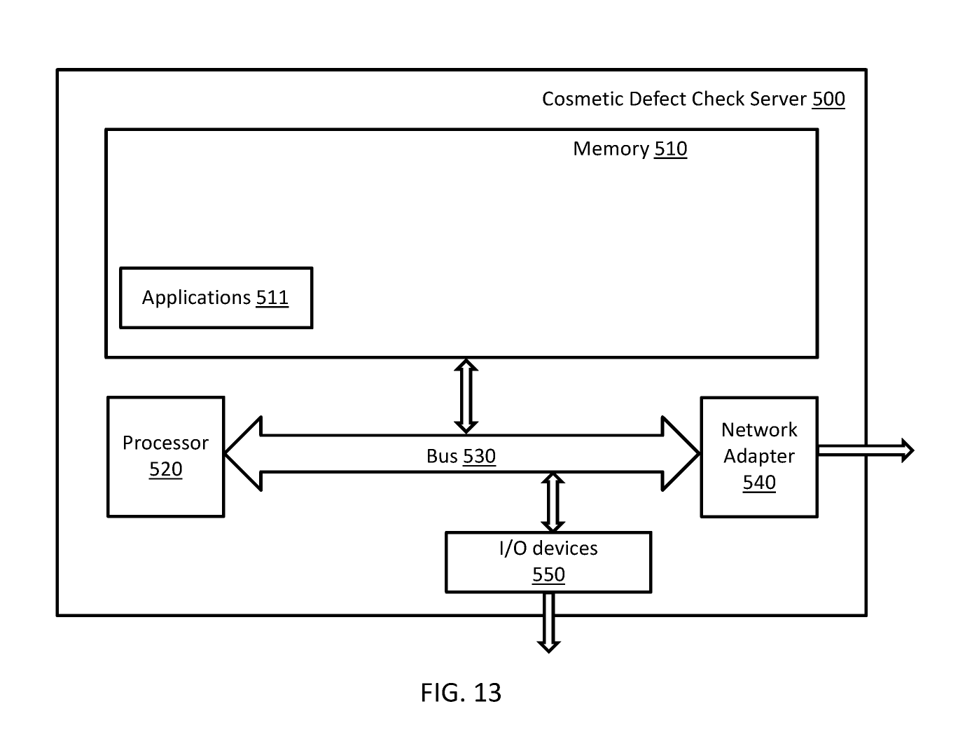

FIG. 13 schematically illustrates an example data processing unit in the form of a cosmetic defect evaluation server 500 suitable for practicing embodiments of the disclosure. Cosmetic defect evaluation server 500 includes a processor 520 and is operatively coupled with retail desktop module 400 so as to receive and evaluate images for cosmetic defects, generate defect maps of tested mobile devices and/or generate defect indices therefor. Cosmetic defect evaluation server 500 may be communicatively coupled with retail desktop module 400, for example, by a communications network 230 forming part of a system 200. In an example, evaluation of images for cosmetic defects, generation of defect maps of tested mobile devices and generation of defect indices for the mobile device are performed at retail desktop module 400 and cosmetic defect evaluation server 500 is employed to store and serve data regarding tested devices, associated defects and/or defect thresholds.

Cosmetic defect evaluation server 500 includes, but is not limited to, a memory 510, computing hardware such as a processor 520, a network adapter 540, I/O devices 550 and a system bus 530 that operatively couples various components including memory 510, processor 520, I/O devices 550 and network adapter 540. I/O devices 550 include a display screen for presenting graphical images to a user of cosmetic defect server 500. Cosmetic defect evaluation server 500 also includes a power source (not shown) for supplying electrical power to the various components thereof. The power source may, for example, include a rechargeable battery.

Memory 510 optionally includes non-removable memory, removable memory, or a combination thereof. The non-removable memory, for example, includes Random-Access Memory (RAM), Read-Only Memory (ROM), flash memory, or a hard drive. The removable memory, for example, includes flash memory cards, memory sticks, or smart cards.

Memory 510 stores applications 511. Applications 511 may, for example, include or be part of a computer program product associated with the cosmetic defect evaluation service provided by cosmetic defect server 500. Executing the computer program product on processor 520 results in generating and rendering, to the display screen, a graphical user interface configured to facilitate user interactions with the cosmetic defect evaluation service.

Further, processor 520 and the interface may be configured for displaying or otherwise presenting evaluations of a device being tested and/or images produced by a test rig.

In some examples, the display screen may be a touch-sensitive display screen that is operable to receive tactile inputs from the user. These tactile inputs may, for example, include clicking, tapping, pointing, moving, pressing and/or swiping with a finger or a touch-sensitive object like a pen to enable access and/or control of various functions of the cosmetic defect evaluation system and service.

Additionally or alternatively, I/O devices 550 include a mouse or a joystick that is operable to receive inputs corresponding to clicking, pointing, and/or moving a pointer object on the graphical user interface. I/O devices 550 may also include a keyboard that is operable to receive inputs corresponding to pushing certain buttons on the keyboard. Additionally, I/O devices 550 may also include a microphone for receiving an audio input from the user, and a speaker for providing an audio output to the user.

Furthermore, network adapter 540 optionally allows cosmetic defect server 500 to receive output from processor 420 such as that stored to memory 410. For example, retail desktop module 400 may upload output to server 500 via communication network 230. Additionally, network adapter 540 may allow cosmetic defect server 500 to access database 225 and historical data stored therein to improve the effectiveness of identifying defects through ongoing training of a machine learning component, to update golden samples and/or to update user-configured standards. Further, network adapter 540 may enable cosmetic defect server 500 to serve updates of the computer program product to retail desktop module 400 and/or serve one or more new computer program products associated with the defect evaluation service.

Moreover, network interface 540 optionally allows cosmetic defect server 500 to communicate with other servers, with retail desktop modules and/or data processing units, for example, via communication network 230.

The cosmetic defect server 500 is optionally implemented by way of at least one of: a tablet computer, a UMPC, a PDA, a web pad, a PC, a handheld PC, a laptop computer, a desktop computer, an NAS device, a large-sized touch screen with an embedded PC, and an interactive entertainment device, such as a game console, a TV set and an STB.

In systems wherein a retail desktop module does not process images of the device being test, when executed on processor 520, applications 511 are configured to process images of the device being tested including, but not limited to, producing one or more final or composite images. Images captured by test rig 300 under a variety of lighting conditions are combined to yield high fidelity images enabling detection of all present defects. Upon execution of the computer program product, processor 520 is adapted and/or configured to process, into one or more final images, captured images of the device being tested. Images may be combined in any of a variety of ways including by high dynamic range algorithms.

In an embodiment, identifying one or more defects, which may further include distinguishing between unevenness, scratches, wear, dents, cracks or discoloration may be performed by cosmetic defect evaluation server 500.

In an embodiment, computation of a defect index may be executed by cosmetic defect evaluation server 500. In an example, the defect index may represent a single, numerical score between 0 for an unacceptably damaged device and 100 for a device in new condition.

In an example, with a defect index computed, an evaluation of the device being tested may be issued and presented to a user interface such as a display of I/O devices 550 of cosmetic defect evaluation server 500.

Obtained starting images, final images, defect identities, defect intensities, defect locations, defect bounding boxes, defect indices of devices being tested may be provided to a historical storage at a database 225 in association with cosmetic defect server 500 for use in updating golden samples and/or for improving the effectiveness of identifying defects through ongoing machine learning.

FIG. 13 is merely an example, which should not unduly limit the scope of the claims herein. It is to be understood that the specific designation for the cosmetic defect evaluation server 500 is provided as an example and is not to be construed as limiting cosmetic defect evaluation server 500 to specific numbers, types, or arrangements of modules and/or components of cosmetic defect evaluation server 500. A person skilled in the art will recognize many variations, alternatives, and modifications of embodiments of the disclosure.

Additionally, in an example, a defect map may be created to provide locations of defects on a device. An example defect map may include one of more bounding boxes delineating defects present on a mobile device and may be formed, in part, based upon information reflecting which camera captured the defect and/or which sub-block contains the defect and/or a surface area of the associated bounding boxes.

In one embodiment, capturing the plurality of images of the device being tested is performed with one or more cameras of the device which are local to the device and/or at least partially housed thereby. In an embodiment, the processor executing one or more of composer 414, communication unit 416 and recognition unit 418 is a component of the device being tested and local thereto. In an example, the processor may be at least partially contained within a housing of the device being tested and be configured to process images and identify defects.

In an embodiment, as part of a set up or initialization process, a number of new or mint or control mobile device makes and models are placed in a test rig individually and a plurality of images of an exterior of the devices are captured with one or more cameras under a plurality of lighting conditions. Captured images are processed into composed images, defect maps and/or defect indices. One or more of the composed images, defect maps and/or defect indices are stored in a golden samples database for each control mobile device.

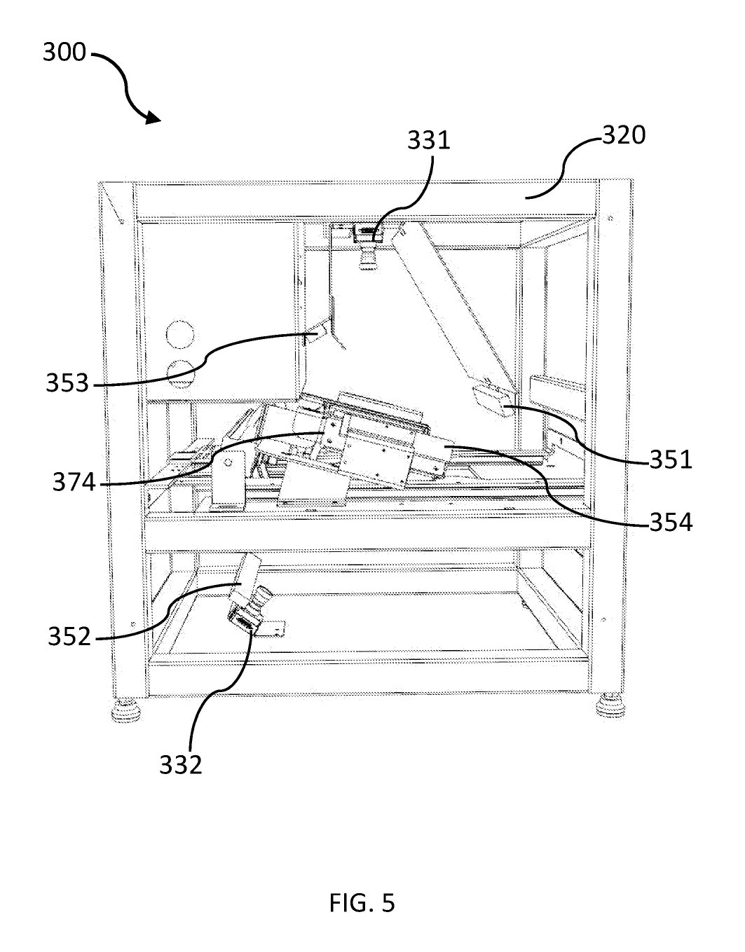

During subsequent testing, composite images, defect maps and/or defect indices of devices being tested are compared to the corresponding golden samples to determine the extent of cosmetic defects present on/with the device being tested. In an example, a golden samples database (FIG. 2) is operatively coupled with and managed by a cosmetic defect evaluation server (FIG. 4) so as to form part of a server subsystem. The golden samples database is operatively coupled with a retail desktop module (FIG. 5) through the cosmetic defect evaluation server, for example, by way of a communications network.

In one embodiment, a bounding box may be used to determine how many pixels of a device screen are affected by a defect or to determine how many pixels of a final image of the device being tested are affected by the defect. In one example, the pixel count may be used to determine the surface area affected by the defect.

It will be appreciated that features of the disclosure are susceptible to being combined in various combinations without departing from the scope of the disclosure as defined by the appended claims.

Embodiments of the disclosure are susceptible to being used for various purposes, including, though not limited to, enabling users to evaluate the cosmetic state of a device being received at a retail store for repair. The state at which a device is received is recorded with this system such that when the device is returned to the customer it can be shown that device is being returned at the same cosmetic defect level.

In another example, the cosmetic state of devices is recorded when they arrive at a warehouse for reverse logistics processing operations. This state can then be used for future reference.

Modifications to embodiments of the disclosure described in the foregoing are possible without departing from the scope of the disclosure as defined by the accompanying claims. Expressions such as “including”, “comprising”, “incorporating”, “consisting of”, “have”, “is” used to describe and claim the disclosure are intended to be construed in a non-exclusive manner, namely allowing for items, components or elements not explicitly described also to be present. Reference to the singular is also to be construed to relate to the plural.

What is claimed is:

1. A method for evaluating cosmetic defects of a device comprising:
capturing a plurality of images of an exterior of the device under a plurality of lighting conditions;
processing the images of the device into one or more final images;
identifying one or more defects of the device from the final images;
computing a defect index based upon the identified one or more defects; and
issuing an evaluation of the device based upon the defect index in accordance with user-configured standards.

2. The method as set forth in claim 1, wherein capturing the plurality of images of the device further comprises adjusting lighting conditions with a plurality of light sources.

3. The method as set forth in claim 1, wherein capturing the plurality of images of the device further comprises capturing the plurality of images with a plurality of noncoplanar cameras.

4. The method as set forth in claim 1, wherein capturing the plurality of images of the device further comprises capturing images of all sides of the exterior without movement of the device.

5. The method as set forth in claim 1, wherein identifying one of more defects further comprises distinguishing between unevenness, scratches, wear, dents, cracks or discoloration.

6. The method as set forth in claim 1, further comprising identifying a location for one or more of the identified defects of the device.

7. The method as set forth in claim 1, further comprising determining a surface area of a bounding box delineating one or more of the defects of the device.

8. The method as set forth in claim 1, wherein computing the defect index further comprises computing the defect index from one or more of a location for one or more of the identified defects and a surface area of a bounding box delineating one or more of the identified defects.

9. A system for evaluating cosmetic defects of a device comprising:
at least one test rig configured to capture a plurality of images of an exterior of the device; and
a processor configured to:
process images of the device captured by the at least one test rig into one or more final images;
identify one or more defects of the device from the final images;
compute a defect index based upon the identified one or more defects; and
issue an evaluation of the device based upon the defect index in accordance with user-configured standards.

10. The system as set forth in claim 9, wherein the at least one test rig further comprises a plurality of light sources.

11. The system as set forth in claim 9, wherein the test rig further comprises a plurality of noncoplanar cameras.

12. The system as set forth in claim 9, wherein the test rig is configured to capture the plurality of images of the exterior of the device from all sides without movement of the device.

13. The system as set forth in claim 9, wherein one or more defects are identified by distinguishing between unevenness, scratches, wear, dents, cracks or discoloration.

14. The system as set forth in claim 9, wherein the processor is further configured to identify a location for one or more of the identified defects of the device.

15. The system as set forth in claim 9, wherein the processor is further configured to determine a surface area of a bounding box delineating one or more of the identified defects of the device.

16. The system as set forth in claim 9, wherein the processor is further configured to compute the defect index from one or more of a location for one or more of the identified defects and a surface area of a bounding box delineating one or more of the identified defects.

17. A computer program product including a non-transitory computer-readable storage medium storing computer-executable code for evaluating cosmetic defects of a device, wherein the code, when executed, is configured to cause one or more computers to:
record a plurality of images of an exterior of the device under a plurality of lighting conditions;
process the images of the device into one or more final images;
identify one or more defects of the device from the final images;
compute a defect index based upon the identified one or more defects; and
issue an evaluation of the device based upon the defect index in accordance with user-configured standards.

18. The computer program product as set forth in claim 17, wherein the code configured to cause the one or more computers to record a plurality of images of the device is further configured to cause the one or more computers to adjust lighting conditions with a plurality of light sources.

19. The computer program product as set forth in claim 17, wherein the code configured to cause the one or more computers to record the plurality of images is further configured to cause the one or more computers to record the plurality of images with a plurality of noncoplanar cameras.

20. The computer program product as set forth in claim 17, wherein the code configured to cause the one or more computers to record the plurality of images is further configured to cause the one or more computers to record images of all sides of the exterior without movement of the device.

21. The computer program product as set forth in claim 17, wherein the code configured to cause one or more computers to identify one of more defects is further configured to cause one or more computers to distinguish between unevenness, scratches, wear, dents, cracks or discoloration.

22. The computer program product as set forth in claim 17, wherein the code, when executed, is further configured to cause one or more computers to identify a location for one or more of the identified defects of the device.

23. The computer program product as set forth in claim 17, wherein the code, when executed, is further configured to cause one or more computers to determine a surface area of a bounding box delineating one or more of the defects of the device.

24. The computer program product as set forth in claim 17, wherein the code configured to cause one or more computers to compute the defect index is further configured to cause the one or more computers to compute the defect index from one or more of a location for one or more of the identified defects and a surface area of a bounding box delineating one or more of the defects of the device.

25. A method for evaluating cosmetic defects of a device comprising:
recording a plurality of images of the device under a plurality of lighting conditions;
processing the images of the device into one or more final images;
identifying one or more defects of the device from the one or more final images; and
computing a defect index from the one or more identified defects.
